(19) United States
(12) Patent Application Publication
(10) Pub. No.: US 2006/0093781 A1
(43) Pub. Date: May 4, 2006

(54) Pile fabric

(76) Inventors: Minoru Kuroda, Himeji-shi, Hyogo (JP); Yoshinori Shibukawa, Himeji-shi, Hyogo (JP)

Correspondence Address: BRINKS HOFER GILSON & LIONE, P.O. BOX 10395, CHICAGO, IL, 60610, US

(21) Appl. No.: 10/521,667

(22) PCT Filed: Jul. 11, 2003
(86) PCT No.: PCT/JP03/08867

§ 371 Date: Sep. 16, 2005

(30) Foreign Application Priority Data
Jul. 19, 2002 (JP) 2002-211542

(51) Int. Cl. B32B 3/02; B32B 33/00

(52) U.S. Cl. 428/89; 428/88; 428/92; 428/97

(57) ABSTRACT

The present invention aims at providing a pile fabric that has excellent voluminous touch and recovery property while exhibiting soft touch, and touch closely equivalent to natural furs. The present invention relates to a pile fabric having a level difference comprising at least a longer pile part and a shorter pile part, wherein a fiber with a flat cross section shape as a shorter pile part is included at a percentage of 30% to 70% by weight to a total weight of the pile part, a difference between an average pile length of the longer pile part, and an average pile length of the shorter pile part is 1 mm to 5 mm, a fineness of a fiber constituting the longer pile part (DL) is in a range of 0.7 dtex to 8 dtex, and a ratio with respect to a fineness of a fiber constituting a shorter pile part (DS) satisfies a relationship of 0.1<(DL/DS)<1.0.

### FIELD OF THE INVENTION

The present invention relates to a pile fabric product having touch equivalent to natural furs.

### BACKGROUND ART

Natural furs comprise, in general, fibers having finer fineness in an end portion compared with that in a root portion, which may exhibit distinctive touch demonstrating excellent handling property with soft feel on a surface thereof and simultaneously with voluminous touch and recovery property. There has eagerly demanded for development of pile products similar to natural furs, that is, pile products having soft touch on a surface thereof, voluminous touch to compression, and excellent resilience.

Since acrylic fiber or acrylic based fiber (hereinafter referred to as “acrylic based fiber” by making both into a group) may give easily especially soft touch in synthetic fibers, pile products similar to natural furs using acrylic based fiber have been conventionally marketed. In the case, fibers having uniform fineness in a lengthwise direction are generally used. Use of a fiber having a same fineness as a fineness in a root portion of natural furs gives resilience, but simultaneously gives harsh touch, and on the other hand, use of a fiber having a same fineness as a fineness in an end portion of natural furs gives touch without resilience. These problems disable realization of pile products with touch similar to natural furs in present circumstances.

As technique for obtaining pile products having similar touch with natural furs using synthetic fibers until now, there may be mentioned, for example:

a technique wherein a pile end portion of a pile product comprising polyester product is immersed into an alkali aqueous solution and hydrolyzed to give finer end portion, as shown in Japanese Patent Laid-Open No. 55-16906; and

a technique wherein an end portion of converged polyester fibers is immersed into an alkali aqueous solution to obtain finer end portion, as shown in Japanese Patent Laid-Open No. 56-134272.

There may also be mentioned:

a technique wherein using a fiber with a Y character cross section having splittable end portion, external stress is applied on the fiber to split the end portion to give distinctive soft touch for a fineness of a root portion, as shown in Japanese Patent Laid-Open No. 1-51564 official report;

and a report for solving the problems wherein a pile fabric exhibiting specific thickness-compressive stress characteristics is obtained using a controlled-sized fiber having non-circular cross section for bristle portion, as shown in Japanese Patent Laid-Open No. 10-158959 official report.

In Japanese Patent Laid-Open No. 8-260289 official report, a technique for realizing any of soft feeling, blooming property, and standing state is disclosed, wherein a pile fabric is constituted from a shrinkable fiber having not more than 0.230 of coefficient of static friction between fiber-fiber and a non-shrinkable fiber having a flat or elliptical cross section. And, in Japanese Patent Laid-Open No. 2000-144557 official report, a pile product is provided wherein use of one or more kinds of circular, kidney, elliptical, cocoon, and flat shape as a fiber cross section shape of middle hair and/or down hair, improves bulkiness and resilient touch in a pile composition using a acrylic fiber consisting of bristle, middle hair, and down hair.

Furthermore, as shown in Japanese Patent Laid-Open No. 2-139476 official report, a technique is also disclosed wherein plurality of single fibers including bristle fibers are adhered together to obtain one unit of fibers, subsequently, this unit of fibers is bundled together by adhesion in a shape of point of a brush to realize imitation of a tapered structure as found in natural furs.

However, pile fabrics obtained by these methods or artificial furs using fibers obtained by these methods as a bristle portion have disadvantage for failing to exhibit characteristics similar to natural furs, or for requiring higher production cost.

### SUMMARY OF THE INVENTION

The present invention aims at providing a pile fabric at low price that has excellent voluminous touch and recovery property while exhibiting soft touch, that is, a pile fabric that exhibits excellent handling property as a pile fabric, and touch closely equivalent to natural furs.

Wholehearted investigations performed by the present inventors revealed that a pile fabric excellent in voluminous touch and recovery property while maintaining soft touch may be obtained by setting of a fineness of a fiber constituting a shorter pile part larger than a fineness of a fiber constituting a longer pile part, and simultaneously by adoption of a flat shape as a fiber cross section shape of a fiber constituting a shorter pile part, and that a relationship of componential number of a fiber constituting a longer pile part and a fiber constituting a shorter pile part (that is, percent of content), and also difference of an average pile length between a fiber constituting a longer pile part and a fiber constituting a shorter pile part play an important role.

That is, the present invention relates to a pile fabric having a level difference comprising at least a longer pile part and a shorter pile part, the pile fabric including a fiber with a flat cross section shape as a shorter pile part at a percentage of 30% to 70% by weight to a total weight of the pile part, the pile fabric having 1 mm to 5 mm of a difference between an average pile length of the longer pile part and an average pile length of the shorter pile part, a fineness of a fiber constituting the longer pile part (DL) in a range of 0.7 decitex to 8 decitex (hereinafter, referred to as dtex), and having a ratio with respect to a fineness of a fiber constituting a shorter pile part (DS) satisfying a relationship of 0.1<(DL/DS)<1.0.

As a preferable embodiment, the present invention relates to the pile fabric having a fineness of a fiber constituting the longer pile part (DL) in a range of 1.5 dtex to 6 dtex.

As a more preferable embodiment, the present invention relates to the pile fabric having an aspect ratio of 5 to 15 of a cross section of the fiber constituting the shorter pile part, and a fineness of the fiber constituting the shorter pile part of 5 dtex to 12 dtex. Furthermore, the fiber constituting the shorter pile part is preferably a shrinkable fiber having 10% to 40% of dry heat shrinkage percentage.

Furthermore, in the pile fabric, effect of the present invention may notably be exhibited by applying organo polysiloxanes on a surface of the fiber constituting the longer pile part.

In an other preferable embodiment, the present invention relates to a pile fabric having 12 mm to 25 mm of an average pile length of the longer pile part, wherein a fiber constituting the shorter pile part is an acrylic based fiber consisting of an acrylonitrile based polymer including 35% to 98% by weight of a repeating unit originating in acrylonitrile.

### BRIEF DESCRIPTION OF THE DRAWINGS

FIG. 1 (pile componential part) is a figure showing a level difference in a pile fabric having level difference. In the FIG. 1, a referential notation a represents a longer pile part, and a referential notation b a shorter pile part. In the FIG. 1, a referential notation c represents a pile length (a length from a root portion to an end portion of the pile part of a fiber constituting the pile part) of the longer pile, and a referential notation d represents a pile fabric. A pile length of the shorter pile part is a length from a root portion to an end portion of the shorter pile part.

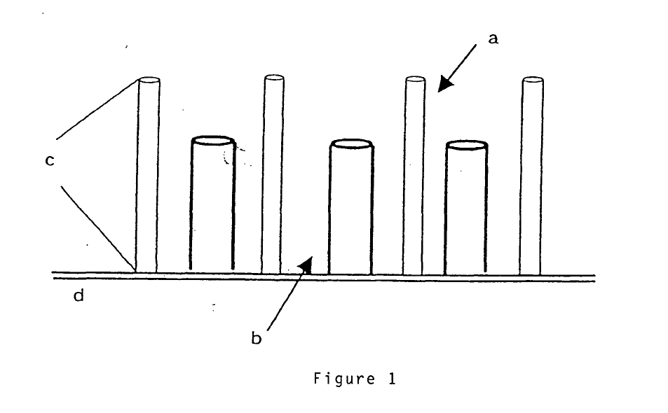

### BEST MODE FOR CARRYING OUT OF THE INVENTION

A pile fabric of the present invention is a pile fabric with a level difference, comprising at least a longer pile part and a shorter pile part, the pile fabric including a fiber having a flat cross section shape as a shorter pile part at a percentage of 30% to 70% by weight to a total weight of the pile part, the pile fabric having 1 mm to 5 mm of a difference between an average pile length of the longer pile part, and an average pile length of the shorter pile part, a fineness of a fiber constituting the longer pile part (DL) in a range of 0.7 dtex to 8 dtex, and a ratio with respect to a fineness of a fiber constituting a shorter pile part (DS) satisfying a relationship of 0.1<(DL/DS)<1.0. A pile fabric having a level difference in the present invention represents a high pile. Since a high pile fabric has various pile length as compared with a boa fabric and adopts designed knitting, it has advantages of enabling wide range of arrangements as an article, of demonstrating satisfactory drape and stretch properties of fabric, of exhibiting no pile cracking, and low price.

A pile fabric of the present invention satisfying the above mentioned constituent features is a satisfactory fabric giving voluminous touch and excellent recovery property, while exhibiting soft touch to touching of the pile surface.

In general pile fabrics known until now, it has been accepted, in general, that a fineness of a fiber constituting a longer pile part is a same or larger than a fineness of a fiber constituting a shorter pile part, and a fiber cross section shape of fiber constituting a shorter pile part has circular, elliptical, cocoon, and dock bone shape. On the other hand, in the present invention, soft and flexible touch may be exhibited in pile ends portion with a low fiber density by setting a fineness of a fiber constituting a longer pile part smaller than a fineness of a fiber constituting a shorter pile part, and by giving a flat shape to a fiber cross section shape of the fiber constituting the shorter pile part, and furthermore use of larger fineness of a fiber in a shorter pile part than in a longer pile part exhibits excellent voluminous touch and excellent recovery property in a middle to root portion of a hair in a lengthwise direction, resulting in touch of satisfactory handling property as a whole pile fabric. These configuration imitates a tapered structure found in natural furs, and in order to realize these advantages, on one hand a componential number (that is, percent of content) of a fiber constituting a longer pile part and a component number of a fiber constituting a shorter pile part are important factor, and on the other hand, a difference between an average pile length of the fiber constituting the longer pile part and an average of the fiber constituting the shorter pile part is also an important factor.

Hereinafter, a pile fabric of the present invention will be described. A pile fabric having level difference of the present invention is characterized in that a fineness (DL) of a fiber constituting a longer pile part is smaller than a fineness of (DS) of a fiber constituting a shorter pile part, and a ratio of fineness of a fiber DL/DS necessarily satisfies a relationship of 0.1<DL<1.0, preferably 0.15<DL/DS<0.80, and more preferably 0.35<DL/DS<0.75. In case of DL/DS being less than 0.1, a small DL reduces convergence between single fibers constituting the longer pile part, and voluminous touch, and a large DS decreases soft feeling, leading to decrease in quality of a resulting pile fabric. On the other hand, a DL/DS exceeding 1.0 loses difference with pile fabrics having conventional two-layered structure, and cannot exhibit tapered effect of the present invention, failing to provide a pile fabric having satisfactory handling property.

In the present invention, a fineness of a fiber (DL) constituting a longer pile part is in a range of 0.7 dtex to 8 dtex, and especially in order to notably exhibit effect of the present invention, it is preferably 1.5 dtex to 6 dtex, and more preferably in a range of 3.3 dtex to 6 dtex. A fineness of a fiber (DL) of less than 0.7 dtex induces decrease in workability, such as in carding, and decrease in quality by convergence of single fiber as a pile fabric. On the other hand, a fineness of a fiber (DL) exceeding 8 dtex reduces softness in a pile fabric, and simultaneously cannot fully exhibit tapered effect of the present invention.

On the other hand, although a fineness of a fiber constituting a shorter pile part (DS) will not especially be limited as long as the above-mentioned relationship of the fineness of a fiber ratio, it is preferably in a range of 5 dtex to 12 dtex. A fineness of a fiber constituting a shorter pile part (DS) of less than 5 dtex cannot support fibers constituting the pile part, and makes the tapered effect of the present invention difficult to be exhibited, and on the other hand, although (DS) exceeding 12 dtex can support fibers constituting the longer pile part, it gives hard touch, leading to a tendency to reduce soft feeling as a whole pile fabric.

Furthermore, in a pile fabric of the present invention, a fiber constituting a shorter pile part is necessarily included at a percentage of 30% to 70% by weight, and a fiber constituting a longer pile part at 70% to 30% by weight. Less than 30% by weight of a fiber constituting a short pile cannot support fibers constituting a longer pile part, and gives a pile fabric with poor voluminous touch and recovery property, and on the other hand, more than 70% by weight of a fiber constituting a short pile remarkably reduces handling property to provide only a fabric with low quality having an insufficient and thin longer pile part. Contents of each of these fibers are optimally preferably in a range of 40% to 60% by weight, respectively.

Furthermore, in the present invention, a difference between an average pile length of a longer pile part and an average pile length of a shorter pile part is 1 mm to 5 mm, and preferably 2 mm to 4 mm. Less than 1 mm of the difference of the average pile length makes smaller a level difference of fibers constituting a longer pile part and fibers constituting a shorter pile part, and cannot provide sufficient effect of handling property. On the other hand, the difference not less than 5 mm cannot fully exhibit effect of a shorter pile part supporting a longer pile part, and, although giving soft touch, it gives a pile fabric with poor recovery property.

In the present invention, it is important for a fiber constituting a shorter pile part to have a flat section, and an aspect ration is preferably 5 to 15, and more preferably 7 to 13. An aspect ratio of not less than 15 gives poor voluminous touch and recovery property, and on the other hand, an aspect ratio of less than 5 gives little differences with conventional shrinkable fibers, hardly disabling coexistence of soft touch, and voluminous touch and recovery property. An aspect ratio is a value obtained by dividing a major axis width by a minor axis width. A major axis width represents a maximum distance between two parallel straight lines circumscribed to a fiber section, and a minor axis represents a fiber section width sandwiched by two lines parallel to an extreme breadth direction, that is, major axis.

In the present invention, although cross section shape of a fiber constituting a longer pile part is not especially limited, it has preferably a non-flat cross section, and as examples, round shape, elliptical shape, dog bone type, etc. may be mentioned.

Moreover, a pile fabric of the present invention may be a two-step pile fabric consisting only of a longer pile part and a shorter pile part, and may be a pile fabric having three or more steps with a medium pile part therein. In the case, the medium pile part is regarded as a part of a shorter pile part or a longer pile part.

Although methods for obtaining a fabric with level difference of the present invention is not especially limited, a method is preferable wherein a shrinkable fiber as a fiber constituting a shorter pile part is used, and the level difference is developed by making only the shorter pile part shrunk by heat treatment at the time of pile fabric production. Besides, it is common to perform heat treatment at this time by back coating treatment.

A shrinkage percentage of a shrinkable fiber is represented by dry heating shrinkage percentage in the present invention. In a dry heating shrinkage percentage measurement, a fiber before shrunk is measured for a sample length (Lb) under a load of 8.83×10⁻³ cN/dtex, then, treatment for 130 degree C.×20 minutes is performed for this fiber sample in a soak oven under no-load, and the fiber sample treated is measured for a sample length after shrinkage at this time under load in a same manner as mentioned above, referred to as La. Dry heating shrinkage percentage will be calculated in a following equation.
Dry heating shrinkage percentage (%)=[(Lb−La)/Lb]×100

From a viewpoint of sufficient demonstration of a level difference effect with a longer pile part, and bulkiness, etc. in a state of pile fabric, a dry heating shrinkage percentage of this fiber constituting a shorter pile part is preferably 10% to 40%, and more preferably 18% to 25%. A dry heating shrinkage percentage of less than 10% does not provide sufficient level difference effect as a pile fabric with level difference, failing to give soft touch. On the other hand, a dry heating shrinkage percentage exceeding 40% clarifies level difference with a longer pile part, give poor recovery property. Of course, there is no limitation when making level difference developed by other methods.

In a pile fabric of the present invention, application of organo polysiloxanes to a surface of a fiber constituting a longer pile part may enhance effect of the present invention. In this case, the organosiloxane may or may not be applied to a fiber constituting a shorter pile. As the organosiloxanes, at least one kind may preferably be used selected from dimethylpolysiloxanes, amino-modified silicones, epoxy-modified silicones, and carboxy-modified silicones. The organo polysiloxane is applied to a fiber surface in a form of a treating solution, and treatment at temperatures of not less than 90 degrees C. after application of the treating solution can exhibit higher softening effect. A more preferable temperature range of this treatment temperature is not less than 100 degrees C.

Moreover, from a viewpoint of viscosity adjustment and stability with the passage of time, the treatment liquid including the organo polysiloxane as a principal component is preferably obtained by emulsifying organo polysiloxanes in water using a surface active agent. Furthermore, in order to increase affinity with fibers, this emulsified treatment liquid preferably has a viscosity not more than 500 cp (at normal temperature). Application build-up of the organo polysiloxane on a surface of fibers is 0.01% to 0.7% by weight to a weight of the fibers, and preferably 0.03% to 0.5% by weight. An application build-up of less than 0.01% by weight gives feeling of low waxy touch, and fails to exhibit touch of natural furs, and on the other hand, an application build-up exceeding 0.7% by weight gives sticky touch and possible poor touch.

In a pile fabric of the present invention, a preferable range of an average pile length in a longer pile part is 12 mm to 25 mm, and more preferably 14 mm to 22 mm. A pile length of longer pile part of less than 12 mm does not exhibit sufficient tapered effect of the present invention, but sometimes results in a pile fabric having poor soft feeling, even if there is given a significant level difference. On the other hand, a pile length exceeding 25 mm is apt to provide a pile fabric insufficient in recovery property, even if the conditions are fulfilled for raw stock component of the pile fabric.

A pile part in the present invention represents standing portion excluding a portion of a base fabric (portion of ground yarn) of pile fabric (standing fabric). Moreover, a pile length represents a length from a root to an end of the standing portion.

An average pile length is obtained in a way that fibers constituting a pile part of a pile fabric is made to stand perpendicularly so that lie of piles are gathered, measured is a length of fibers constituting a pile part between a root (root on a surface of the pile fabric) and an end of a longer pile part or a shorter pile part at ten places, and an average is calculated.

Furthermore, a fiber constituting a shorter pile part in the present invention is preferably an acrylic based fiber. Since fibers of a shorter pile part supports fibers of a longer pile part to maintain standing fabric state, vinyl chloride fibers, polyester fibers, etc. have a higher specific gravity, and are inferior to acrylic based fibers in bulkiness. Furthermore, polyester fibers have significant defect of poor elongation of piles. Therefore, use in a shorter pile part of these fibers reduces handling property of the pile fabric. In addition, kinds of fibers constituting a longer pile part are not limited in this case.

An acrylic based fiber used herein represents a fiber consisting of an acrylic based polymer, and the fiber is of a copolymer obtained from a monomer including acrylonitrile 35% to 98% by weight, other vinyl based monomer(s) copolymerizable with acrylonitrile 65% to 2% by weight, and vinyl based monomer(s) including sulfonic acid group copolymerizable with them 0% to 10% by weight. More preferably, a content of acrylonitrile is 35% to 90% by weight.

The vinyl based monomer copolymerizable with acrylonitrile includes:

halogenated vinyls and halogenated vinylidenes represented by vinyl chloride, vinylidene chloride, vinyl bromide, vinylidene bromide, etc.;

unsaturated carboxylic acids represented by acrylic acid and methacrylic acid and salts thereof;

acrylic esters and methacrylic esters represented by methyl acrylate and methyl methacrylate;

esters of unsaturated carboxylic acid represented by glycidyl methacrylate etc.;

vinyl esters represented by vinyl acetate and butyric acid vinyl;

vinyl based amides represented by acrylamide and methacryl amide; and

methacryl sulfonic acid well-known vinyl compounds, such as vinylpyridine, methyl vinyl ether, and methacrylonitrile. The fiber may be of an acrylic based copolymer obtained by copolymerizing one or two or more kinds of them.

Moreover, as the vinyl based monomer including sulfonic acid group, there may be mentioned:

styrene sulfonic acid, para-styrene sulfonic acid, allyl sulfonic acid, methacryl sulfonic acid, para methacrylyl oxy-benzenesulfonic acid, methacrylyl oxy-propyl sulfonic acid, or metal salts, amine salts thereof, etc.

Since a pile fabric of the present invention has soft touch, excellent voluminous touch and excellent recovery property, and touch extremely similar to natural furs, and exhibits advantageous value in optimal fields of high pile fabric for especially garments applications, such as fake furs, in addition to stuffed toys.

The present invention will hereinafter be described in detail with reference to Examples, but the present invention is not intended to be limited to these at all. In advance of description of Examples, description about analysis conditions, measurement conditions, and evaluation method will hereinafter be given.

### EXAMPLE

(A) Fineness Test

A fineness of a fiber was measured using an auto vibro type fineness test machine Denior Computer DC-11 (made by Search Control Electric Co., Ltd.), and an average of number of samples n=25 was used.

(B) Aspect Ratio Measurement

Using S-3500N scanning electron microscope (made by Hitachi, Ltd.), a major axis width and minor axis width of a fiber section were measured, by observation of a fiber section where Au was vapor-deposited with ion coater IB-3 type (made by Eiko Engineering Co., Ltd.). In major axis width and minor axis width an average of n=25 was used. From this major axis width and minor axis width, an aspect ratio=(major axis width)/(minor axis width) was obtained.

(C) Preparation of High Pile Fabric

Necessary treatment and operation of oils application, machine crimping, cutting, etc. were performed to an obtained fiber. Machine crimp used here represents a crimp obtained by well-known methods, such as a gear crimping method and a stuffing box method, and it is not especially limited. As preferable crimped shape, a crimp percentage is 4% to 15%, and preferably 5% to 10%, and a number of crimps is in a range of 6 to 15 crimps/inch, and preferably of 8 to 13 crimps/inch. The crimp percentage mentioned above is obtained by measuring method described in JIS L 1074.

Then, these fibers were cut and a pile fabric was knitted with a sliver knitting machine. Subsequently, pre-polishing treatment and pre-shearing treatment were performed at 120 degrees C. to control a pile length. A back coating was given with an acrylic ester based adhesive on a pile back face. Then, 155-degree C. polishing, and subsequently brushing were performed, and furthermore, polishing and shearing were carried out in combination at 135 degree C., 120 degrees C., and 90 degrees C. (2 times for each process) to remove crimps in a standing surface side, and thus a standing fabric with a fixed pile length was manufactured.

(D) Touch Evaluation of a Pile Fabric

A pile fabric formed as mentioned above was evaluated for handling property by touch sensuous evaluation by four-step evaluation of standard shown hereinafter. Besides, handling property used here represents characteristic of presenting flexible and soft touch, excellent voluminous touch and excellent recovery property as whole of a pile fabric.

⊚: exhibiting excellent handling property and very similar touch to natural furs

◯: exhibiting good handling property and similar touch to natural furs

Δ: exhibiting a little inferior handling property as compared with natural furs

X: exhibiting inadequate handling property and not similar to natural furs

(E) Measurement of Average Pile Length

Fibers constituting a pile part in a pile fabric were made to stand perpendicularly so that lie of hair gathers. Each length from a root of a fiber constituting the pile part to an end of a longer pile part or a shorter pile part (not a length from a back face of the pile fabric) was measured for at 10 points using a slide caliper. Then an average value was calculated for an average pile length.

(F) Measurement of Level Difference of Pile

A level difference between piles is a difference between an average pile length of longer pile part, and an average pile length of shorter pile part measured by the method. The value was calculated by the following equation.
Level difference (mm)=(average pile length of longer pile part (mm))−(average pile length of shorter pile part (mm))

### Manufacturing Example 1

An acrylic based copolymer obtained from acrylonitrile 49 parts by weight; vinyl chloride 50 parts by weight; and sodium styrenesulfonate 1 part by weight was dissolved in acetone. Titanium oxide 0.3 parts by weight was added to the acrylic based copolymer 100 parts by weight to obtain a spinning solution. The spinning solution was wet-spun into a coagulation bath including an aqueous solution having 30% of acetone concentration through a spinneret having a pore size of 0.04×0.65 mm and a number of holes 7133. The spun fiber was subsequently introduced into two aqueous solution baths each having 35% and 25% acetone concentration to give 2.0 times of drawing. The drawing of 3.0 times in total together with the previous drawing was then given to the fiber in a 90-degree C. aqueous washing bath. Then, the obtained fiber was given oils thereon, and dried under 125-degree C. atmosphere. Furthermore, the fiber was drawn so that a total draft might become 6.5 times as a final draft at 125 degrees C. to obtain a shrinkable fiber with a single fiber fineness 7.8 dtex.

### Manufacturing Example 2

Spinning was performed in a same manner as in Manufacturing Example 1 through a spinneret of 0.04 mm×0.24 mm of pore size, and a number of holes 16667, using a similar spinning solution as in Manufacturing Example 1 to obtain a shrinkable fiber with a single fiber fineness of 3.3 dtex.

### Manufacturing Examples 3 to 4

An acrylic based copolymer obtained from acrylonitrile 93% by weight, and vinyl acetate 7% by weight was dissolved in dimethylacetamide (henceforth, DMAc). Titanium oxide 0.3 parts by weight was furthermore added into the acrylic based polymer 100 parts by weight to obtain a spinning solution. This spinning solution was wet-spun in a coagulation bath containing an aqueous solution of 60% by weight of DMAc concentration, through a spinneret having 0.04 mm×0.65 mm of pore size, and a number of holes 7133 (Manufacturing Example 3), and through a spinneret having 0.11 mm of pore size, and a number of holes 19500 (Manufacturing Example 4). Furthermore, the fibers obtained were drawn 2.0 times while solvent was being washed in boiling water, and subsequently, the fibers were given oils thereon and dried with a 130-degree C. heated roller. Moreover, the dried fibers were drawn 2.0 times in a 70-degree C. hot water to obtain a shrinkable fiber of 7.8 dtex (Manufacturing Example 3) and 5.6 dtex (Manufacturing Example 4).

### Manufacturing Example 5

Fiber formation was performed on a similar spinning solution/spinneret/spinning conditions as in Manufacturing Example 1. Subsequently, heat-treating was performed so that a final draft might become 6.5 times under 135-degree C. atmosphere, and a shrinkable fiber of a single fiber fineness 7.8 dtex was obtained.

Table 1 shows polymer composition, AN % by weight (acrylonitrile % by weight), solvent, fineness of a fiber, aspect ratio, and shrinkage percentage of Manufacturing Example 1 to 5. In polymer composition in Table 1, AN represents acrylonitrile, and VCL represents vinyl chloride, and VAc represents vinyl acetate.

TABLE 1

| | | | | Size | | |
|---|---|---|---|---|---|---|
| Manu- | Polymer | | | of a | | Shrinkage |
| facturing | compo- | AN % by | | fiber | Aspect | percentage |
| Examples | sition | weight | Solvent | (dtex) | ratio | (%) |
| 1 | AN/VCL | 49 | Acetone | 7.8 | 12.3 | 22.1 |
| 2 | AN/VCL | 49 | Acetone | 3.3 | 5.7 | 20.6 |
| 3 | AN/VAc | 93 | DMAc | 7.8 | 10.2 | 23.1 |
| 4 | AN/VAc | 93 | DMAc | 5.6 | 1.2 | 2.2 |
| 5 | AN/VCL | 49 | Acetone | 7.8 | 11.2 | 7.5 |

### Example 1, Example 2

After crimping, the shrinkable fiber obtained in Manufacturing Example 1 was cut into 38 mm length. Subsequently, the shrinkable fiber 40 parts by weight and a commercially available non-shrinkable acrylic based fiber (finishing oil treatment by organosiloxane) “Kanekalon (registered trademark)” AH 3.3 dtex, 38 mm (manufactured by Kaneka Corp.) 60 parts by weight were mixed together to manufacture a pile fabric. AH 3.3 dtex used at this time was packed in a Ober Mayer dyeing machine by a packing density 0.33 g/cm³, and dyeing treatment was performed.

A recipe at this time of: dyestuffs of Maxilon Golden Yellow GL 200% 0.173% omf, Maxilon Red GRL 200% 0.063% omf, and Maxilon Blue GRL 300% 0.111% omf (manufactured by Ciba Specialty Chemicals), and dyeing auxiliary agent of Ultra MT #100 (manufactured by Mitejima Chemicals Co., Ltd.) 0.3 g/L was used. The dyeing machine was heated from room temperature by 3-degree C./minute, and then the temperature was kept at 98 degrees C. for 60 minutes, and dyeing was performed. Obtained pile fabric had 570 g/m² of final weight. In the last shearing process of the pile fabric, piles were cut to give an average pile length of a longer pile part 18 mm. Obtained pile fabric had a touch very similar to natural furs as shown in Table 2 (Example 1).

Moreover, the shrinkable fiber obtained in Manufacturing Example 1 50 parts by weight, and commercially available non-shrinkable acrylic based fiber “Kanekalon (registered trademark)” fmu(10) 1.5 dtex, and 32 mm (manufactured by Kaneka Corp.) 50 parts by weight were mixed to obtain a pile fabric. The obtained pile fabric had a final weight of 570 g/m², and piles of longer pile part were cut to an even average pile length of 15 mm in a last shearing process at the time of pile fabric preparation. The obtained pile fabric had a touch very similar to natural furs as shown in Table 2 (Example 2).

### Example 3

Crimp was given to the shrinkable fiber obtained in Manufacturing Example 2, and then the fiber was cut into 32 mm of length. Subsequently, this shrinkable fiber 40 parts by weight, and a commercially available non-shrinkable acrylic based fiber “Kanekalon (registered trademark)” fmu(10) 1.5 dtex, and 32 mm (manufactured by Kaneka Corp.) 60 parts by weight were mixed to obtain a pile fabric. Obtained pile fabric had a final weight of 570 g/m², and piles of longer pile part were cut to an even average pile length of 15 mm in a last shearing process at the time of pile fabric preparation. Obtained pile fabric had a touch very similar to natural furs as shown in Table 2.

### Example 4

Crimp was given to the shrinkable fiber obtained in Manufacturing Example 3, and then the fiber was cut into 38 mm of length. Subsequently, this shrinkable fiber 50 parts by weight, and a commercially available non-shrinkable acrylic based fiber “Kanekalon (registered trademark)” AH(740) 3.3 dtex, and 38 mm (manufactured by Kaneka Corp.) 50 parts by weight were mixed to obtain a pile fabric. The obtained pile fabric had a final weight of 570 g/m², and piles of longer pile part were cut to an even average pile length of 18 mm in a last shearing process at the time of pile fabric preparation. The obtained pile fabric had touch very similar to natural furs as shown in Table 2.

### Comparative Example 1

Crimp was given to the shrinkable fiber obtained in Manufacturing Example 1, and then the fiber was cut into 38 mm of length. Subsequently, this shrinkable fiber 20 parts by weight, and a commercially available non-shrinkable acrylic based fiber “Kanekalon (registered trademark)” AH 3.3 dtex, and 38 mm (manufactured by Kaneka Corp.) 80 parts by weight were mixed to obtain a pile fabric. The obtained pile fabric had a final weight of 570 g/m², and piles of longer pile part were cut to an even average pile length of 18 mm in a last shearing process at the time of pile fabric preparation. The obtained pile fabric had poor handling property, as shown in

### Comparative Example 2

Crimp was given to the shrinkable fiber obtained in Manufacturing Example 1, and then the fiber was cut into 38 mm of length. Subsequently, this shrinkable fiber 60 parts by weight, and a commercially available non-shrinkable acrylic based fiber “Kanekalon (registered trademark)” PLM 12 dtex, and 44 mm (manufactured by Kaneka Corp.) 40 parts by weight were mixed to obtain a pile fabric. The obtained pile fabric at this time had a final weight of 635 g/m². The piles of longer pile part were cut to an even average pile length of 20 mm in a last shearing process at the time of pile fabric preparation. The obtained pile fabric had poor soft feeling, as shown in Table 2, and it was not suitable as natural furs.

### Comparative Example 3

A commercially available shrinkable acrylic based fiber “Lufnen (registered trademark)” VJR 4.4 dtex, 32 mm (manufactured by Kanebo Gohsen, Ltd.) 50 parts by weight, and a commercially available non-shrinkable acrylic based fiber “Kanekalon (registered trademark)” AH(10) 5.6 dtex, 38 mm (manufactured by Kaneka Corp.) 50 parts by weight were mixed to obtain a pile fabric. Moreover, VJR had a fiber section aspect ratio of 4.5, and measurement of dry heating shrinkage percentage gave 28.7%. The pile fabric at this time had a final weight of 570 g/m². The piles of longer pile part were cut to an even average pile length of 14 mm in a last shearing process at the time of pile fabric preparation. The obtained pile fabric had poor recovery property, as shown in Table 2, and it was not suitable as natural furs.

### Comparative Examples 4 to 5

Crimp was given to the shrinkable fiber (Comparative Example 4) obtained in Manufacturing Example 4, and the shrinkable fiber (Comparative Example 5) obtained in Manufacturing Example 5, and subsequently the fibers were cut into 38 mm of length. Subsequently, the shrinkable fibers 50 parts by weight, and a commercially available non-shrinkable acrylic based fiber “Kanekalon (registered trademark)” AH(740) 3.3 dtex, and 38 mm (manufactured by Kaneka Corp.) 50 parts by weight were mixed to obtain pile fabrics. Obtained pile fabrics had a final weight of 570 g/m², respectively, and piles of longer pile part were cut to an even average pile length of 18 mm in a last shearing process at the time of pile fabric preparation. As shown in Table 2, obtained pile fabrics both had poor soft feeling, and both were not suitable as natural furs.

TABLE 2

| | Size of a | | Kind and percentage of | | Difference of an average | | | |
|---|---|---|---|---|---|---|---|---|
| | fiber of a | | fiber used | | pile length of a longer | | | |
| | longer | | Longer pile | Shorter pile | pile part, and an average | Average | Weight of | Touch |
| | pile part | | part (part | part (part by | pile length of a shorter | pile length | pile fabric | evaluation |
| | (dtex) | DL/DS | by weight) | weight) | pile part (mm) | (mm) | (g/m²) | of pile fabric |
| Ex. 1 | 3.3 | 0.423 | 60 | 40 | 2.7 | 18 | 570 | excellent |
| Ex. 2 | 1.5 | 0.192 | 50 | 50 | 2.3 | 15 | 570 | excellent |
| Ex. 3 | 1.5 | 0.455 | 60 | 40 | 2.2 | 15 | 570 | excellent |
| Ex. 4 | 5.6 | 0.718 | 50 | 50 | 2.7 | 18 | 570 | excellent |
| Comp. Ex. 1 | 3.3 | 0.423 | 80 | 20 | 2.7 | 18 | 570 | poor |
| Comp. Ex. 2 | 12 | 1.538 | 40 | 60 | 3.0 | 20 | 635 | poor |
| Comp. Ex. 3 | 5.6 | 1.272 | 50 | 50 | 2.8 | 14 | 570 | poor |
| Comp. Ex. 4 | 5.6 | 1.000 | 50 | 50 | 2.7 | 18 | 570 | poor |
| Comp. Ex. 5 | 5.6 | 0.718 | 50 | 50 | 0.7 | 18 | 570 | poor |

### INDUSTRIAL APPLICABILITY

According to a pile fabric concerning the present invention, satisfactory handling property as found in natural furs may be obtained.

1. A pile fabric having a level difference comprising at least a longer pile part and a shorter pile part, wherein a fiber with a flat cross section shape as a shorter pile part is included at a percentage of 30% to 70% by weight to a total weight of the pile part, a difference between an average pile length of the longer pile part, and an average pile length of the shorter pile part is 1 mm to 5 mm, a fineness of a fiber constituting the longer pile part (DL) is in a range of 0.7 dtex to 8 dtex, and a ratio with respect to a fineness of a fiber constituting a shorter pile part (DS) satisfies a relationship of 0.1<(DL/DS)<1.0.

2. The pile fabric according to claim 1, wherein a fineness of the fiber of fiber constituting a longer pile part (DL) is in a range of 1.5 dtex to 6 dtex.

3. The pile fabric according to claim 1 or claim 2, wherein an aspect ratio of a cross section of the fiber constituting the shorter pile part is in a range of 5 to 15.

4. The pile fabric according to claim 1 or claim 2, wherein a fineness of the fiber constituting the shorter pile part (DS) is in a range of 5 dtex to 12 dtex.

5. The pile fabric according to claim 1 or claim 2, wherein the fiber constituting the shorter pile part is a shrinkable fiber having 10% to 40% of dry heat shrinkage percentage.

6. The pile fabric according to claim 1 or claim 2, wherein an organo polysiloxane is applied at least on a surface of the fiber constituting the longer pile part.

7. The pile fabric according to claim 1 or claim 2, wherein an average pile length of the longer pile part is 12 mm to 25 mm.

8. The pile fabric according to claim 1 or claim 2, wherein at least a fiber constituting the shorter pile part is an acrylic based fiber consisting of an acrylonitrile based polymer including 35% to 98% by weight of a repeating unit originating in acrylonitrile.
